(19) United States
(12) Patent Application Publication
(10) Pub. No.: US 2011/0073788 A1
(43) Pub. Date: Mar. 31, 2011

(54) MICROVALVE FOR CONTROL OF COMPRESSED FLUIDS

(76) Inventors: Michael A. Marcus, Honeoye Falls, NY (US); Rajesh V. Mehta, Rochester, NY (US); Kam C. Ng, Rochester, NY (US)

(21) Appl. No.: 12/570,312

(22) Filed: Sep. 30, 2009

(51) Int. Cl. F16K 31/12; F16K 31/02

(52) U.S. Cl. 251/30.01; 251/129.01

(57) ABSTRACT

A micro-electromechanical device for controlling compressed fluid flow is provided. A chamber includes a fluid flow inlet port, a high pressure region exceeding 30 bar, and a fluid flow outlet port. A moveable micro-electromechanical valve is positioned to contact the fluid flow outlet port when the moveable micro-electromechanical valve is in a first position. An electrical connection to the moveable micro-electromechanical valve provides an electrical pulse train to the moveable micro-electromechanical valve to actuate the valve at a rate of 10 KHz or more to move the valve in order to control fluid communication between the high pressure region and a low pressure region downstream from the fluid flow outlet port.

### CROSS REFERENCE TO RELATED APPLICATIONS

Reference is made to commonly-assigned, U.S. patent application Ser. No. ______ (Docket 95911), entitled “MICROVALVE FOR CONTROL OF COMPRESSED FLUIDS” filed concurrently herewith.

### FIELD OF THE INVENTION

The present invention relates generally to micro-electromechanical devices and, more particularly, to micro-electromechanical valves that control flow of compressed fluids through fluid channels.

### BACKGROUND OF THE INVENTION

Micro Electro Mechanical Systems (MEMS) are a relatively recent development. They are used in many mass-market commercial devices such as accelerometers, pressure sensors, ink jet printer heads, and digital mirror arrays for projectors. They are also used as alternatives to conventional electromechanical devices as actuators, valves, and position locaters. They are potentially low cost due to use of microelectronic fabrication techniques. G. Stemme provides a useful review of techniques and principles that can be used to fabricate MEMS liquid flow control devices in a paper entitled “Micro fluid sensors and actuators” in IEEE Proceedings of Sixth International symposium on Micro Machines and Human Sciences, pp. 45-52 (1995).

MEMS microvalves are characterized by their geometry, actuation mechanism, whether they are active or passive, normally open or closed, and whether they contain external or integrated actuators. Additionally, their membrane material can also be used to characterize them. Membrane materials are typically divided into silicon-based and non silicon-based. “Normally open” (“closed”) simply means that the valve is open (closed) when no power is applied. Most MEMS microvalves are silicon-based since they are created using existing silicon chip fabrication methods established by the electronics industry. Newer MEMS fabrication techniques such as Lithographie Galvanoformung Abformung (LIGA), LIGA-like and Deep Reactive Ion Etching (DRIE), etc. permit mass fabrication, including non-silicon parts, with high aspect ratios. Other materials previously incorporated into microvalve designs include Titanium, Nickel, Copper, Aluminum, and Silicon. Stainless steel is also often used for these purposes.

The actuation mechanism in active microvalves includes a means to open and close an orifice and regulate the flow. This classification can be further divided into external and integrated actuators. External actuators include solenoid plungers, piezoelectric stack actuators, and pneumatic devices. Integrated actuators provide an intrinsic mechanism to actuate the valve such as electrostatic attraction, heating of bimetallic strips, thermo-pneumatic (heating/expansion), shape memory alloy (SMA), and electromagnetic. Each type of mechanism offers advantages and disadvantages in terms of cost, complexity, speed, performance, and reliability. These factors need to be optimized for the given applications.

The number and variety of application areas for microvalves for flow control have been increasing rapidly due to their small size, low-power consumption and relatively large flow rates. These include micro-propulsion, refrigeration, fuel injection, liquid chromatographic separations, and chemical synthesis. An interesting emerging application is compressed fluid based printing. Compressed fluids are fluids that contain at least one component in substantial amount that is gas at ambient temperature and pressure.

In a paper entitled “Leak-tight piezoelectric microvalve for high-pressure gas micro-propulsion” published in J. of Microelectromechanical Systems, 13, p. 799 (2004), E. Yang et al. describe the development of a normally-closed piezoelectric microvalve that operated successfully up to inlet pressure of about 68 bar and an actuation repetition frequency of 1 KHz. Similarly, in a paper entitled “piezoelectric microvalve for compact high-frequency, high differential pressure hydraulic micro-pumping systems” published in J. of Microelectromechanical Systems, 12, p. 81 (2003), D. C. Roberts et al. describe the development of a piezoelectrically driven hydraulic amplification microvalve. The microvalve operated successfully at pressure differentials of 4-10 bar and actuation repetition frequency of 1-10 KHz, with a large stroke (20-30 μm) B. J. Kirby et al. describe “Voltage-addressable on/off microvalves for high-pressure microchip operations” in a paper published in J. of Chromatography A, 979, p. 147 (2002). They demonstrate that the glass substrates and cross-linked polymer monoliths can operate in water-acetonitrile mixtures and hold-off pressures up to 350 bar with open/closed flow ratios of 10⁴ to 10⁶ over the pressure range of 1.5-70 bar and operates at a frequency of 1 Hz. In a paper published in Sensors and Actuators A, 134, p. 257 (2007), D. G. Lee et al. describe “Large flow rate/high frequency microvalve array for high performance actuators”. They use silicon-on-insulator wafer to simplify the fabrication process. Their microvalves have an analytical resonant frequency of 50 KHz and operate at pressure differentials of up to 1.4 bar. A useful comparison of various microvalves for gas flow is also available in a paper entitled “Design, fabrication and characterization of a novel gas microvalve using micro- and fine machining” by I. Fazal et al. published in J. of Micromechanics and Microengineering, 16, p. 1207 (2006). Most of the microvalves included in this review did not exhibit an ability to control flows for pressure differentials exceeding 25 bar. Microvalves with thermal or thermo-pneumatic actuation provide large force through large stroke but slow response time (>300 ms).

The microvalves described above represent a range of options available in terms of differential pressures, frequency, response time, stroke, size, and complexity of fabrication. However, none of the published valve designs appear to be capable of providing a way to control flow of compressed fluids to meet combined requirements such as being able to operate at the required pressure (for example, >30 Bar), in a leak-proof manner (for example, open/closed flow ratio>1000), at the desired high actuation frequency (for example, >10 KHz) and of desired compactness (for example, that enables making a nozzle array that permits printing at resolutions exceeding 150 dots per inch). It would be desirable to have microvalve architectures providing these improved operating characteristics. As such, there is a need for new valve designs that solve the problem of simultaneously satisfying such requirements for the control of compressed fluid flows.

Commonly assigned U.S. Pat. No. 6,464,341 entitled “Dual Action Thermal Actuator and Method of Operating Thereof” issued Oct. 15, 2002 to Furlani et al., describes a method and apparatus for operating a thermal actuator as a liquid drop emitter in an inkjet print head. The disclosed thermal actuator includes a base element and a cantilevered element extending from the base element, and normally residing at a first position before actuation. The cantilevered element includes a barrier layer, constructed of a low thermal conductivity material bonded between a first deflector layer and a second deflector layer, both of which are constructed of electrically resistive materials having substantially equal coefficients of thermal expansion. The thermal actuator also includes a first pair of electrodes connected to the first deflector layer and a second pair of electrodes connected to the second deflector layer for applying electrical pulses to cause resistive heating of the first or second deflector layers, resulting in thermal expansion of the first or second deflector layer relative to each other. Application of an electrical pulse to either pair of electrodes causes deflection of the cantilevered element away from its first position, and, alternately, causes a positive or negative pressure in the liquid at the nozzle of a liquid drop emitter. The actuator never needs to close fully in order to control the formation of ink droplets.

Commonly assigned U.S. Pat. No. 6,588,884, entitled “Tri-Layer of Thermal Actuator and Method of Operating” issued Jul. 8, 2003 to Furlani et al., describes an apparatus and method of operating a thermal actuator for a liquid drop emitter such as an inkjet print head. The disclosed thermal actuator includes a base element and a cantilevered element extending from the base element and normally residing at a first position before actuation. The cantilevered element includes a barrier layer constructed of a low thermal conductivity material, bonded between a deflector layer and a restorer layer, both of which are constructed of materials having substantially equal coefficients of thermal expansion. The thermal actuator also includes an apparatus adapted to apply a heat pulse directly to the deflector layer, causing a thermal expansion of the deflector layer relative to the restorer layer and deflection of the cantilevered element to a second position, followed by restoration of the cantilevered element to the first position as heat diffuses through the barrier layer to the restorer layer and the cantilevered element reaches a uniform temperature. When used as a thermal actuator for liquid drop emitters, the cantilevered element resides in a liquid filled chamber that includes a nozzle for ejecting liquid. Application of a heat pulse to the cantilevered element causes deflection of a free end forcing liquid from the nozzle. It is not necessary to close a valve for successful operation of this device.

Commonly assigned U.S. Pat. Nos. 7,033,000, issued Apr. 25, 2006 to Delametter et al., and 7,029,101, issued Apr. 18, 2006 to Delametter et al., both entitled “Tapered Multi-Layer Thermal Actuator And Method Of Operating Same” disclose different embodiments of apparatus for and method of operating a thermal actuator for a micromechanical device, especially a liquid drop emitter for use in an ink jet printhead. The disclosed thermal actuator includes a base element and a cantilevered element including a thereto-mechanical bender portion extending from the base element to a free end tip. The thermo-mechanical bender portion includes a bather layer constructed of a dielectric material having low thermal conductivity, a first deflector layer constructed of a first electrically resistive material having a large coefficient of thermal expansion, and a second deflector layer constructed of a second electrically resistive material having a large coefficient of thermal expansion wherein the barrier layer is bonded between the first and second deflector layers.

US Patent Application Publication No. 2009/0079783 A1, published Mar. 26, 2009, by Mehta et al., discloses a MEMS print head based printing apparatus. It is used for delivering a mixture of compressed fluid and marking material and depositing the marking material in a pattern on to a substrate. The print head includes individually controlled microvalves positioned along each micro-nozzle, with typical turn on- and off-times in the range 10⁻⁵ to 10⁰ sec. For control of flow of supercritical gases, such microvalves have to operate at input side pressures exceeding the critical pressure of the gas. For example, the use of supercritical carbon dioxide typically requires the microvalve to operate at input pressure exceeding 73 bar.

The design and fabrication of microvalves for use in environments that have high operating pressures and high actuation frequencies present new challenges. Accordingly, there is an ongoing need for microvalves that operate adequately in these types of environments.

### SUMMARY OF THE INVENTION

The abovementioned thermal cantilever based designs are be attractive for compressed fluid flow control if they can be used as valves instead of drop emitters. However, we have found through calculations that for a desired temperature increase, a cantilever element that is exposed to net pressure across its entire length (i.e., when it is uniformly loaded) bends progressively less as operating pressure is increased. Hence, for sufficiently high pressures, such as those required for compressed fluids, a cantilever beam with, for example, thermal stimulation will have zero deflection across its length and will not open sufficiently. It is not apparent that any known modifications serve to ameliorate the situation. The results of trial-and-error computational experiments have unexpectedly revealed features of the present invention that should be present in designs of microvalves, for example, cantilever based microvalves, in order to make them suitable for use in compressed fluid flow control applications.

According to one aspect of the present invention, a micro-electromechanical device for controlling compressed fluid flow is provided. A chamber includes a fluid flow inlet port, a high pressure region exceeding 30 bar, and a fluid flow outlet port. A moveable micro-electromechanical valve is positioned to contact the fluid flow outlet port when the moveable micro-electromechanical valve is in a first position. An electrical connection to the moveable micro-electromechanical valve provides an electrical pulse train to the moveable micro-electromechanical valve to actuate the valve at a rate of 10 KHz or more to move the valve in order to control fluid communication between the high pressure region and a low pressure region downstream from the fluid flow outlet port.

According to another aspect of the present invention, a method of controlling compressed fluid flow includes providing a source of compressed fluid, the compressed fluid being under a pressure of at least 30 bar; providing a micro-electromechanical device including: a chamber including a fluid flow inlet port, a high pressure region, and a fluid flow outlet port, the fluid flow inlet port being in fluid communication with the source of compressed fluid; a moveable micro-electromechanical valve positioned to contact the fluid flow outlet port when the moveable micro-electromechanical valve is in a first position; and an electrical connection to the moveable micro-electromechanical valve; and actuating the moveable micro-electromechanical valve at a rate of 10 KHz or more by providing an electrical pulse train to the moveable micro-electromechanical valve using the electrical connection to control fluid communication between the high pressure region and a low pressure region downstream from the fluid flow outlet port.

According to another aspect of the present invention, a compressed fluid microvalve for controlling flow of compressed fluid from a region of high pressure to a region of low pressure is provided. A chamber includes an inlet port, a region of high pressure, and an outlet port leading to a region of low pressure. A cantilever beam includes a first portion, a second portion, and a third portion. The cantilever beam is anchored to a portion of the chamber and is suspended in the chamber such that the first portion and third portion of the cantilever beam are exposed to the region of high pressure on all sides. The second portion of the cantilever beam overlaps the outlet port. The cantilever beam includes a first position in contact with the outlet port to prevent fluid flow from the chamber through the outlet port and a second position removed from contact with the outlet port to permit fluid flow from the chamber through the outlet port. A controller is in electrical communication with the cantilever beam and is configured to provide an actuation pulse to the cantilever beam to move the cantilever beam from the first position in contact with the outlet port to the second position removed from contact with the outlet port.

According to another aspect of the present invention, a method of controlling compressed fluid flow includes providing a source of compressed fluid; providing a compressed fluid microvalve including: a chamber including an inlet port, a region of high pressure, and an outlet port leading to a region of low pressure, the inlet port being in fluid communication with the source of compressed fluid; and a cantilever beam including a first portion, a second portion, and a third portion, the cantilever beam being anchored to a portion of the chamber and being suspended in the chamber such that the first portion and third portion of the cantilever beam are exposed to the region of high pressure on all sides, and the second portion of the cantilever beam overlaps the outlet port, the cantilever beam including a first position in contact with the outlet port to prevent fluid flow from the chamber through the outlet port and a second position removed from contact with the outlet port to: permit fluid flow from the chamber through the outlet port; providing a controller in electrical communication with the cantilever beam; and actuating the cantilever beam using the controller to move the cantilever beam from the first position in contact with the outlet port to the second position removed from contact with the outlet port.

According to another aspect of the present invention, a normally closed or a normally open micro-electromechanical valve unit for controlling flow of compressed fluids from a region of high pressure to a region of low pressure is provided. A microfluidic chamber includes an inlet and an outlet for fluid. The chamber accommodates a valve element. The valve element includes a base element that provides an anchor and a valve seat defining an outlet conduit. The outlet conduit provides fluid communication between a high pressure region and a low pressure region. A deflectable cantilevered element including a bender portion extends from the anchor on the base element to a free end tip residing either at a first position in sealing contact with the valve seat or at a second position spaced apart or removed from contact with the valve seat. When in the first position, the cantilevered element experiences an unbalanced force only on the portion of the cantilevered element circumscribed by the valve seat such that the fluid communication between the high pressure region and the low pressure region is restricted. When in the second position, the cantilevered element permits fluid communication between the high pressure region and the low pressure region. A pair of electrodes are electrically connected to the deflectable cantilevered element to apply an electrical pulse to the deflectable cantilevered element, the application of which results in deflection of the cantilevered element to the second position, followed by restoration of the cantilevered element to the first position.

### BRIEF DESCRIPTION OF THE DRAWINGS

In the detailed description of the preferred embodiments of the invention presented below, reference is made to the accompanying drawings, in which:

FIG. 1A is a schematic view of a bi-layer microvalve in its closed position according to a first embodiment of this invention;

FIG. 1B is a schematic view of a bi-layer microvalve in its open position according to a first embodiment of this invention;

FIG. 2A is a schematic view of a tri-layer microvalve in its closed position according to a second embodiment of this invention;

FIG. 2B is a schematic view of a tri-layer microvalve in its open position according to a second embodiment of this invention;

FIG. 3A is a schematic view of the bottom surface of the bi-layer microvalve shown in FIG. 1A;

FIG. 3B is a schematic view of the bottom surface of the tri-layer microvalve shown in FIG. 2A;

FIG. 4 is the geometry used for calculating the resonance frequency of a bimorph beam;

FIG. 5 is a schematic view of a uniformly loaded bi-layer microvalve in its closed position;

FIG. 6 plots defection of a uniformly loaded bi-layer microvalve versus position along the beam at different loading pressures for a 200 degree C. temperature difference;

FIG. 7 plots defection of a partially loaded bi-layer microvalve versus position along the beam at different loading pressures for a 200 C degree C. temperature difference;

FIG. 8 plots deflection of a partially loaded bi-layer microvalve as a function of the location of the microvalve seat along the length of the microvalve at different loading pressures for a 200 degree C. temperature difference;

FIG. 9 plots deflection of a partially loaded tri-layer microvalve as a function of position along the beam as described in Example 1;

FIG. 10 plots the maximum temperature in the partially loaded tri-layer microvalve as a function of time as described in Example 1;

FIG. 11 plots deflection of a partially loaded bi-layer microvalve as a function of position along the beam as described in Example 2; and

FIG. 12 plots the maximum temperature in the partially loaded bi-layer microvalve as a function of time as described in Example 2.

### DETAILED DESCRIPTION OF THE INVENTION

The present description will be directed in particular to elements forming part of, or cooperating more directly with, apparatus in accordance with the present invention. It is to be understood that elements not specifically shown or described can take various forms well known to those skilled in the art. Figures shown and described herein are provided in order to illustrate key principles of operation of the present invention and are not drawn with intent to show actual size or scale. Some exaggeration may be necessary in order to emphasize relative spatial relationships or principles of operation.

As used herein, the term “compressed fluid” is defined to include a liquid having a density equal to greater than 0.1 g per cubic centimeter; or a supercritical fluid having density equal to or greater than 0.1 g per cubic centimeter; or a compressed gas having a density equal to or greater than 0.1 g per cubic centimeter or any combination thereof. Materials that are above their critical point, defined by a critical temperature and a critical pressure, are known as supercritical fluids. The critical temperature and critical pressure typically define a thermodynamic state in which a fluid or a material becomes supercritical and exhibits gas like and liquid like properties. Ambient conditions are preferably defined as temperature in the range from −100 to +100° C., and pressure in the range from 1×10⁻³-100 bar for this application.

It is well known that the shape of the thermo-mechanical bender portion of a cantilevered thermal actuator influences its performance. Similarly, the shape of the piezoelectric bender portion of a cantilevered piezoelectric actuator influences its performance. The cantilevered element is designed to have a length sufficient to result in an amount of deflection sufficient to meet the requirements of the microvalve application. The details of thermal expansion differences, stiffness, modulus of elasticity, density, thickness, piezoelectric coefficients and other factors associated with the layers of the thermo-mechanical or piezoelectric bender portion are considered in determining an appropriate length for the cantilevered element. The length is also limited by the desired maximum frequency of operation. It is preferable that the cantilever element includes two or more layers, thus forming a multilayered thermo-mechanical or piezoelectric device.

The width of the cantilevered element is important in determining the force that is achievable during actuation. The actuation moves a fluid mass and overcome counter forces. In order to operate as a leak proof microvalve, the actuator compresses materials at the seat of the valve to achieve good contact or sealing. In general, for a given length and material layer construction, the force that can be generated is proportional to the width of the thermo-mechanical or piezoelectric bender portion of the cantilevered element. A straightforward design for a thereto-mechanical or piezoelectric bender is therefore a rectangular beam of width w₀ and length L, wherein L is selected to produce adequate actuator deflection and w₀ is selected to produce adequate force of actuation, for a given set of thermo-mechanical materials and layer constructions.

It is also known that the straightforward rectangular shape mentioned above is not the most energy efficient shape for the thermo-mechanical or piezoelectric bender. In fact, a thermo-mechanical or piezoelectric bender portion that reduces in width from the anchored end of the cantilevered element to a narrower width at the free end produces more force for a given area of the bender.

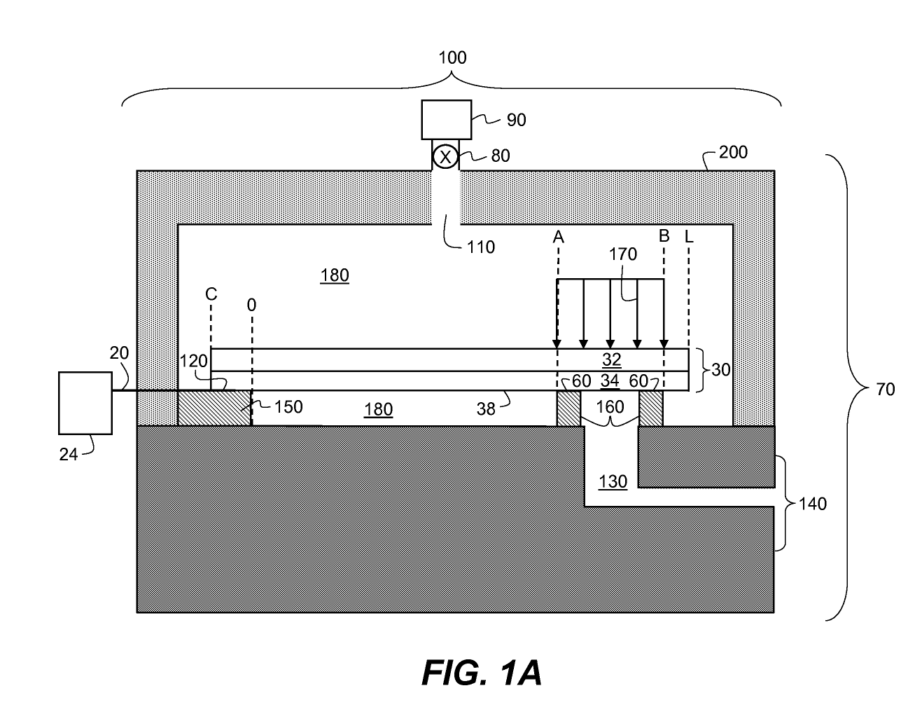

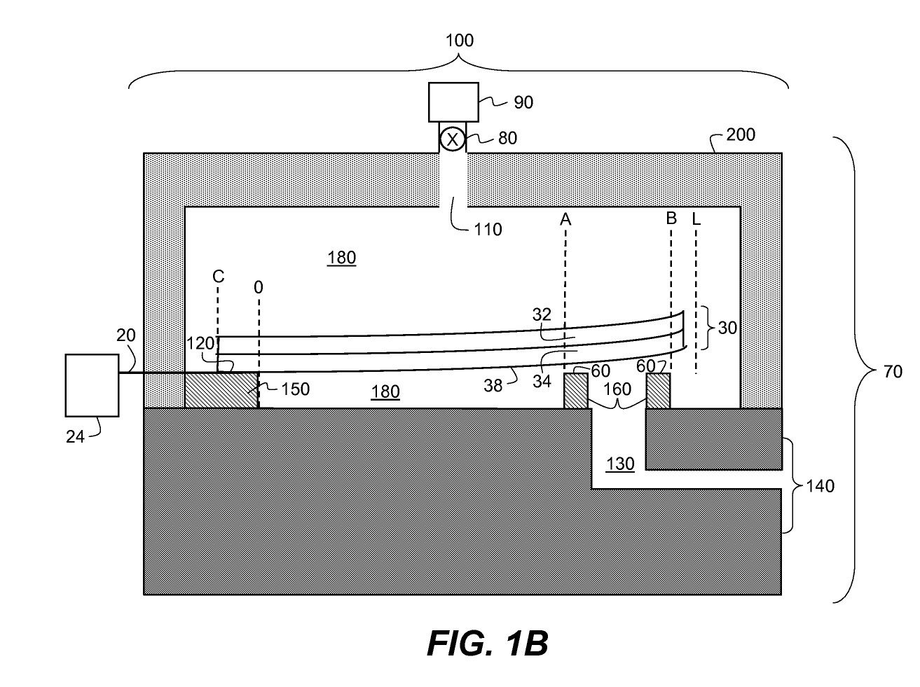

FIG. 1A shows a schematic view of a compressed fluid flow control system 100 utilizing a bi-layer cantilever beam 30 as a microvalve actuator shown in its closed position according to a first embodiment of this invention. The compressed fluid control system 100 includes a compressed fluid source 90, a compressed fluid inlet control valve 80, a microvalve enclosure 70 and a chamber 180 defined as the interior of microvalve enclosure 70.

The microvalve enclosure 70 includes a microvalve enclosure top 200 with a high pressure inlet port 110 in fluid communication with the compressed fluid source 90 and the chamber 180, a microvalve enclosure base 140 with a low pressure outlet port 130 and a controller interface conduit 20 used to provide control signals to actuate the bi-layer cantilever beam 30. In one embodiment of the invention, the bi-layer cantilever beam 30 includes a first layer 34 of a material having a high coefficient of thermal expansion and a second layer 32 of a material having a low coefficient of thermal expansion. The components of microvalve enclosure 70 are sealed together so that chamber 180 maintains a high pressure differential with respect to the outside environment when the cantilever beam 30 is in its closed position as shown in FIG. 1A.

The compressed fluid flow control system 100 can include additional fluid flow channels. When included, the fluid channels that the compressed fluid flows through are, typically, very small in size and are commonly referred to as micro-channels. Either the inlet port, the outlet port, or both ports can be fluidically connected to one or more micro-channels. When the fluid system includes micro-sized channels, actuation of the microvalve actuator, for example, the bi-layer cantilever beam 30, controls compressed fluid flow through the micro-sized channels.

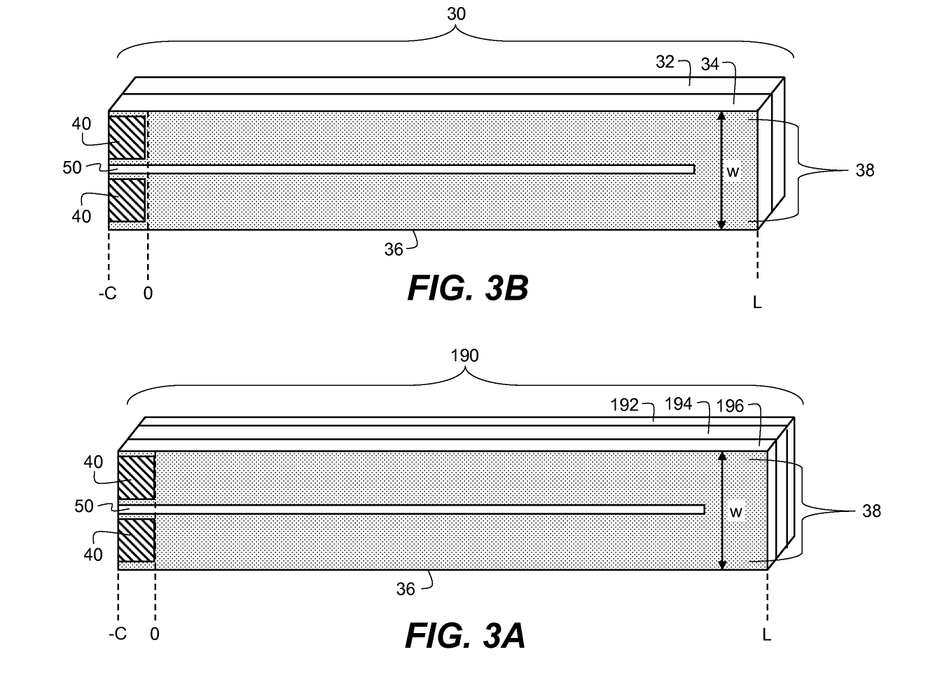

The bi-layer cantilever beam 30 is suspended in the chamber 180 and is supported and bonded to a microvalve anchor 150 and supported by a microvalve seat 160 when in the closed position. We call the closed position a first position which is in contact with the outlet port and prevents the flow of compressed fluid from the chamber through the outlet port. The microvalve anchor 150 is composed of a thermally conductive material and acts as a heat sink. The microvalve anchor 150 and the microvalve seat 160 are attached to the microvalve enclosure base 140 or the microvalve substrate. Alternatively, the microvalve substrate can be a separate part (not shown) that is in intimate contact with the microvalve enclosure base 140. The microvalve seat 160 has the same inner size and shape as the size and shape of the opening in the low-pressure outlet port 130. At the top of the microvalve seat 160 is a microvalve seat interface 60, which makes a tight seal with the bottom surface 38 of the first layer 34 of the bi-layer cantilever beam 30 when the microvalve is in its closed position. The valve seat thus provides a fluid seal when in contact with the cantilever beam in its closed position. The plane labeled 0 or pivot position is located at the right edge of the anchor 150. The bi-layer cantilever beam 30 is attached to the anchor 150 at locations to the left of plane 0. The left end of the cantilever beam 30 is defined as Plane C. The length of attachment of the cantilever to the anchor is thus C which is typically between 5 and 30 μm. The width of the cantilever beam 30 is w (shown in FIG. 3A). The anchor overlap area of the cantilever bimorph microvalve 30 defined by the product wC acts as a heat sink during actuation of the microvalve. Plane L describes the right edge of the cantilever beam 30 of length L with respect to the pivot position of the cantilever beam 30. Plane A is the location of the left edge of microvalve seat 160 and plane B is the location of the right edge of microvalve seat 160. When the bi-layer cantilever beam 30 is in its closed position as shown in FIG. 1A, there is an unbalanced force region 170 located between planes A and B. The pressure P in the unbalanced force region is equal to the pressure of the compressed fluid in the chamber. There is also an unbalanced force on the beam in the region of the beam from C to 0. The unbalanced force in this region has no bearing on the performance of the bi-layer cantilever beam since the beam does not deflect in this region and it serves as an anchor location. It is preferred that the microvalve seat 160 is composed of a thermally conductive material so that the microvalve seat 160 can also act as heat sink when the microvalve 30 is in its closed position.

The microvalve cantilever beam 30 is suspended in the chamber 180 such that it includes a first portion from plane 0 to plane A, a second portion from plane A to plane B, and a third portion from plane B to plane L. The cantilever beam 30 is anchored to a portion of the chamber at one end of the cantilever beam (also referred to as an anchor or anchor portion, the region from plane C to plane 0). The first portion of the cantilever beam 30 extends from the pivot point of the cantilever beam 30 to the second portion of the cantilever beam 30. The second portion of the cantilever beam 30 overlaps the outlet port 130 and includes the microvalve seat 160 and the third portion of the cantilever beam is suspended in the chamber and ends at plane L. The first and third portions of the cantilever beam are subjected to the region of high pressure on all sides at all times. The cantilever beam 30 has a first position in contact with the outlet port 130 to prevent fluid flow from the chamber through the outlet port. As shown in FIG. 1A and a second position as shown in FIG. 1B removed from contact with the outlet port 130 to permit fluid flow from the chamber through the outlet port.

The microvalve cantilever beam 30 has a cantilever electrode contact region 120 located at the interface of the bi-layer cantilever beam 30 and anchor 150. The controller interface conduit 20 is located at the top surface of the microvalve anchor 150 and extends into the cantilever electrode contact region 120 of the microvalve 30. FIG. 3A shows further detail of the bi-layer cantilever beam 30 by showing a bottom surface view of surface 38. The electrode surface of cantilever first layer, 38 includes electrode contact pads 40, electrode 36, and an electrode gap 50. The electrode contact pads 40 are aligned with the cantilever electrode contact region 120 at the top surface of microvalve anchor 150. During manufacturing of the microvalve 30 electrical leads in the controller interface conduit 20 are contacted to the electrode contact pads 40 of electrode 36. A controller 24 provides electrical current to the electrical leads in the in the controller interface conduit 20 which in turn applies current to the electrode surface of the cantilever first layer 38.

The controller 24 is in electrical communication with the first layer 34 of the cantilever beam, the controller being configured to provide an actuation pulse to the first layer of the cantilever beam 34 which moves the cantilever beam 30 from a first closed position in contact with the outlet port 160 through the microvalve seat 160 as shown in FIG. 1A to a second position removed from contact with the outlet port 160 as shown in FIG. 1B. When the actuation pulse is removed from the first layer of the cantilever beam 34, the pressure in the region of high pressure is sufficient to move the cantilever beam 30 from the second position back to the first position.

During operation of microvalve 30 a rapid voltage pulse from the controller 24 via conduit 20 through contact pads 40 is supplied to electrode 36 of the cantilever beam first layer 34. A current flows through the electrode 36 and through the electrical conducting material of first layer 34 creating resistive heating in the layer. This results in a rapid increase in the temperature of the first layer 34. When the first layer is composed of a material with both a high thermal coefficient of expansion and thermal conductivity, this layer will expand in both length and width causing the material to bend upward as the voltage is applied to the electrodes. When the voltage is removed from the electrode 36 of the first layer 34 there will be no more temperature rise in the first layer. As the heat diffuses into the second layer 34 the temperatures of the two layers will equilibrate and the valve will close. Cooling of the bottom layer will occur as heat is lost through the heat sink at the anchor 150 and the valve seat 160 of the microvalve when contact is restored as the microvalve closes.

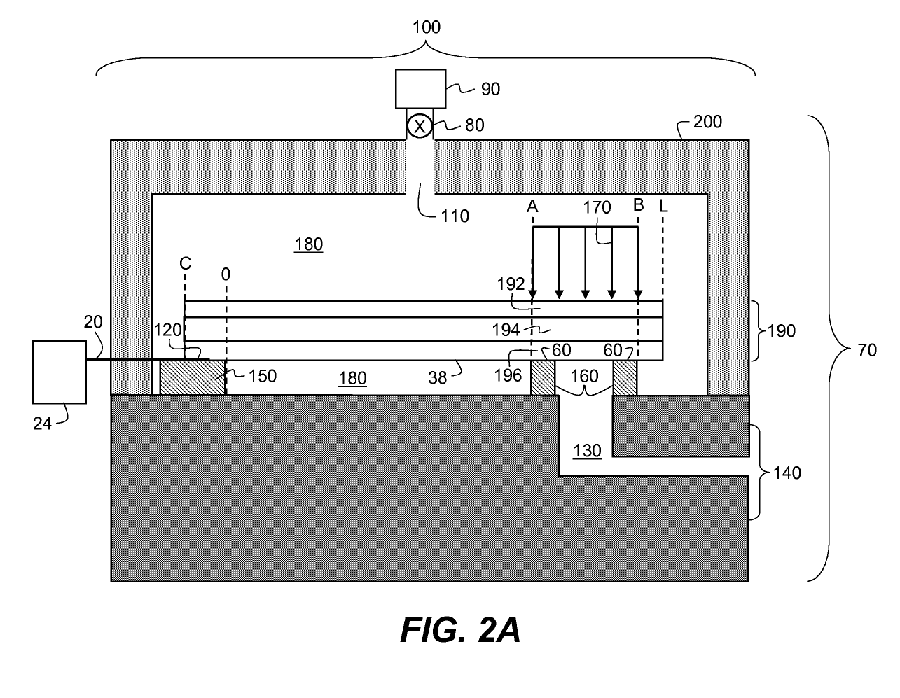

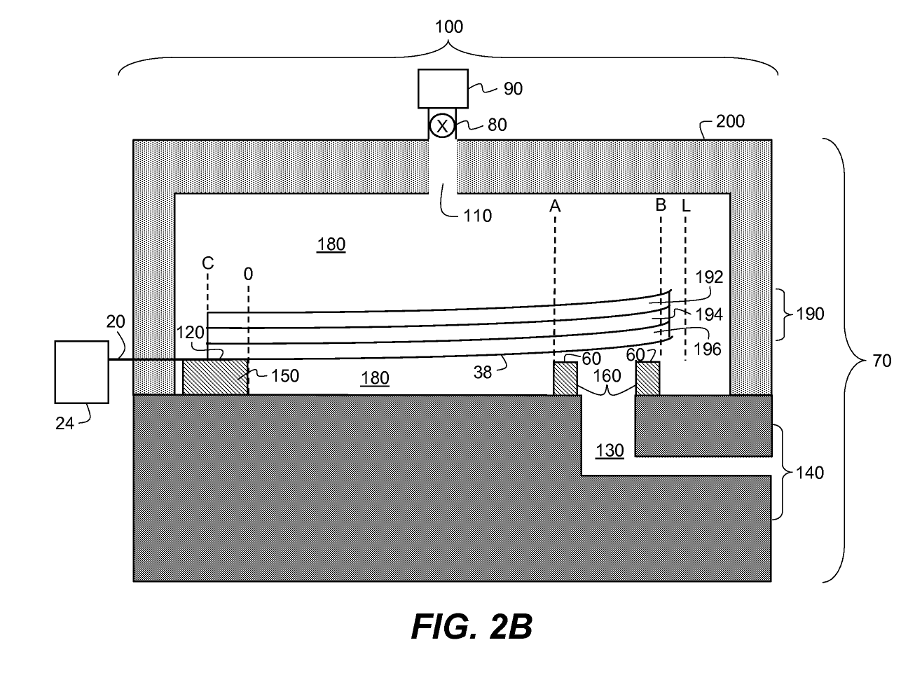

FIG. 2A and FIG. 2B shows a schematic view of a compressed fluid flow control device 100 using a tri-layer cantilever beam 190 as an alternative embodiment of this invention. Tri-layer cantilever beam 190 includes a cantilever first layer 196 of a material having a high coefficient of thermal expansion, a cantilever second layer or middle layer 194 of a material having a low coefficient of thermal expansion and a cantilever third layer 192 of a material having a high coefficient of thermal expansion. FIG. 2A shows the tri-layer cantilever beam 190 in its closed position while FIG. 2B shows the tri-layer cantilever beam 190 in its open position. FIG. 3B shows further detail of the tri-layer cantilever beam 190. The second layer 194 is constructed of a low thermal conductivity and electrically insulating material bonded between a first layer 196 and a third layer 192, both of which are constructed of electrically conductive materials having substantially equal coefficients of thermal expansion. The third layer 192 can have an optional electrode on its top surface (not shown) in order to use this as a second deflection layer as described in co-assigned U.S. Pat. No. 6,464,341 which is incorporated by reference.

During operation of microvalve 190 a rapid voltage pulse from the controller 24 via conduit 20 through contact pads 40 is supplied to electrode 36 of the cantilever beam first layer 196. A current flows through the electrode 36 and through the electrical conducting material of first layer 34 creating resistive heating in the layer. This results in a rapid increase in the temperature of the first layer 196. When the first layer is composed of a material with both high thermal coefficient of expansion and thermal conductivity this layer will expand in both length and width causing the material to bend upward as the voltage is applied to the electrodes. When the voltage is removed from the electrode 36 of the first layer 34 there will be no more temperature rise in the first layer. As the heat diffuses into the second layer 194 and then the third layer 192 the temperatures of the three layers will equilibrate and the valve will close. Applying a voltage to the top layer 192 will cause the beam to bend downward thus ensuring the closing of the valve. The controller is used to provide an actuation pulse to the third layer of the cantilever beam when the cantilever beam is in the second position removed from contact with the outlet port to move the cantilever beam to the first position in contact with the outlet port. This offers a second mechanism to enable valve closing. Cooling of the bottom layer can occur as heat is lost through the heat sink at the anchor 150 and the valve seat 160 of the microvalve when contact is restored as the microvalve closes.

The thermal deflection Y(x,T) of a cantilever bi-layer or bimorph beam of length L from a pivot point defined as 0 as a function of distance x along the length of the beam. The cantilevered element includes a barrier layer, constructed of a low thermal conductivity material bonded between a first deflector layer and a second deflector layer, both of which are constructed of electrically resistive materials having substantially equal coefficients of thermal expansion can be shown to be

Y(x,T)=Y_{M}(x,T)−Yₚ(x) (1)

where Y_{M}(x,T) is the bending due to thermal moment and Y_{P}(x) is the bending due to unbalanced pressure. The first term of equation 1 is given by

$${Y}_{M} ( x , T ) = \frac{M ( T ) {x}^{2}}{2 EI} ) \qquad ( 2 )$$

where EI is the flexural rigidity of the beam and M(T) is the thermal moment of the beam. The flexural rigidity of the beam is the product of the moment of inertia I and the modulus of elasticity E in a single layer beam. For a 2 layer beam EI is given by

$$EI = w \frac{{E}_{1} {E}_{2} {h}_{1} {h}_{2}^{3}}{12 ( {h}_{1} {E}_{1} + {h}_{2} {E}_{2} )} [ 4 + 6 \frac{{h}_{1}}{{h}_{2}} + 4 {( \frac{{h}_{1}}{{h}_{2}} )}^{2} + \frac{{E}_{1}}{{E}_{2}} {( \frac{{h}_{1}}{{h}_{2}} )}^{3} + \frac{{E}_{2}}{{E}_{1}} ( \frac{{h}_{2}}{{h}_{1}} ) ] \qquad ( 3 )$$

where w is the width of the beam, E₁ and E₂ are the moduli of elasticity of the first and second layers and h₁ and h₂ are the thicknesses of the 2 layers. The thermal moment of the beam M(T) is given by

$$M ( T ) = w \frac{{E}_{1} {E}_{2} ( {h}_{1} + {h}_{2} ) {h}_{1} {h}_{2} [ {α}_{1} ( {T}_{1} - {T}_{0} ) - {α}_{2} ( {T}_{2} - {T}_{0} ) ]}{2 ( {h}_{1} {E}_{1} + {h}_{2} {E}_{2} )} \qquad ( 4 )$$

where α₁ and α₂ are the coefficients of thermal expansion of the first and second layers respectively.

For a uniformly loaded bimorph beam the relationship

$${Y}_{P} ( x ) = - \frac{{Pwx}^{2}}{24 EI} ( 6 {L}^{2} - 4 Lx + {x}^{2} ) \qquad ( 5 )$$

can be derived where P is the force per unit area on the beam or the pressure of the compressed fluid.

For a partially loaded bimorph beam the total unbalanced load force is Pw(B−A). The relationship for Y_{P}(x) can be shown to be

$${Y}_{P} ( {x}_{0 - A} ) = - \frac{Pw ( B - A )}{12 EI} ( 3 ( A + B ) {x}^{2} - 2 {x}^{3} ) \\ {Y}_{P} ( {x}_{A - B} ) = - \frac{Pw ( B - A )}{24 EI} ( 6 ( A + B ) {x}^{2} - 4 {x}^{3} + \frac{{( x - A )}^{4}}{B - A} ) \\ {Y}_{P} ( {x}_{B - L} ) = - \frac{Pw ( B - A )}{24 EI} ( 4 ( {A}^{2} + AB + {B}^{2} ) x - {A}^{3} - {AB}^{2} - {A}^{2} B - {B}^{3} ) . \qquad ( 6 )$$

The relationships above for the deflection of bimorph beams are for the case when the beams are driven below the first or fundamental resonance frequency. Resonance frequencies for cantilever beams can be calculated from the theory for the transverse vibrations of a bar fixed at one end from as described in L. Kinsler, A. Frey, Q. Coppens and J Sanders, “Fundamental of Acoustics, Third Edition”, 1982 John Wiley and Sons, pp 72-75. The resonance frequencies f of a beam of a homogeneous material is given by

$$f = \frac{π c κ}{8 {L}^{2}} ( {1.194}^{2} , {2.988}^{2} , {5}^{2} , {7}^{2} , … ) \qquad ( 7 )$$

where c is the speed of sound in the material given by

$$c = \sqrt{\frac{E}{ρ}} \qquad ( 8 )$$

where E is the modulus of elasticity and ρ is the density of the material and κ is the radius of gyration. For a beam of rectangular cross section the radius of gyration is given by

$$κ = \frac{h}{\sqrt{12}} \qquad ( 9 )$$

where h is the thickness of the beam. For the uniform material cantilever beam the fundamental resonance frequency is given by

$${f}_{o} = 0.162 \sqrt{\frac{E}{ρ}} \frac{h}{{L}^{2}} . \qquad ( 10 )$$

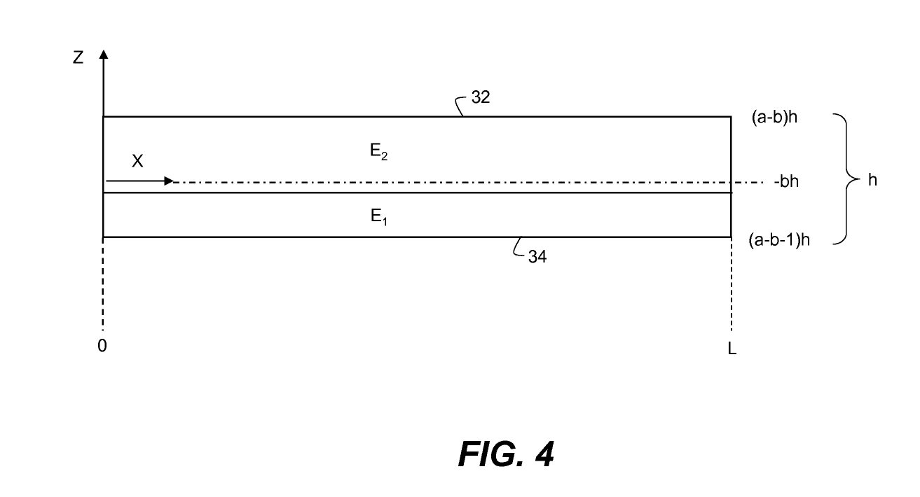

The article by Lee and Marcus titled, “The Deflection Bandwidth Product of Poly(Vinylidene Fluoride) Benders and Related Structures in Ferroelectrics Vol. 32, pp 93-101, 1981 describe the fundamental relationships for deflection and resonance in unimorph, bimorph and multimorph beams. FIG. 4 shows the geometry used for calculating the resonance frequency of a bimorph beam. The variable b defines the location of the neutral axis. The location of the neutral axis is given by the expression

$$b = \frac{1}{2} [ \frac{{a}^{2} C - {( 1 - a )}^{2}}{aC + 1 - a} ] \qquad ( 11 )$$

where C is given by

$$C = \frac{{E}_{2}}{{E}_{1}} . \qquad ( 12 )$$

The resonance frequencies are given by

$$f = \frac{π h}{8 {L}^{2}} \sqrt{\frac{{E}_{1}}{{ρ}_{1}}} \sqrt{\frac{\begin{matrix}[ - {b}^{3} - {( a - b - 1 )}^{3} ] + \\ C [ {( a - b )}^{3} + {b}^{3} ]\end{matrix}}{3 [ 1 - a + Da ]}} ( {1.194}^{2} , {2.988}^{2} , {5}^{2} , {7}^{2} , … ) \qquad ( 13 )$$

where D is given by

$$D = \frac{{ρ}_{2}}{{ρ}_{1}} , h = {h}_{1} + {h}_{2} and a = \frac{{h}_{2}}{h} . \qquad ( 14 )$$

Resonance frequency relationships for tri-layer and multi-layer beams are also derived in the Lee and Marcus reference. Table 1 shows a compilation of materials that are useful for the construction of thermally actuated microvalves according to various embodiments of this invention along with their relevant materials coefficients.

TABLE 1
Properties of Materials Useful in Beam Structures

| | Thermal | | | | Young's | |
|---|---|---|---|---|---|---|
| | expansion | Thermal | Specific | | Modulus | Intrinsic |
| | coefficient | Conductivity | Heat | Density | (10\hat{ }11 | Resistivity |
| Material | (10-6 K-1) | (W/m-K) | (J/g-K) | (g/cm3) | N/m2) | (ohm-cm) |
| Au | 14.2 | 317 | 0.129 | 19.3 | 0.8 | 2.27E−08 |
| Al | 25 | 237 | 0.897 | 2.7 | 0.7 | 2.65E−08 |
| Si | 2.6 | 149 | 0.705 | 2.33 | 1.5 | 2.20E+02 |
| Zn | 35 | 116 | 0.388 | 7.13 | 0.79 | 5.50E−08 |
| Si₃N₄ | 0.8 | 19 | 0.17 | 3.17 | 3.85 | 1.00E+14 |
| Ta | 6.3 | 57.5 | 0.14 | 16.69 | 1.86 | 1.35E−05 |
| Pb | 28.9 | 35 | 0.129 | 11.3 | 0.16 | 2.00E−07 |
| PolySilicon ins | 4.7 | 33.2 | 0.702 | 2.33 | 1.9 | 1.00E+05 |
| Ti | 8.6 | 21.9 | 0.523 | 4.51 | 1.2 | 3.90E−07 |
| nichrome | 10 | 12 | 0.445 | 8.5 | 2.1 | 1.10E−07 |
| SiO2 | 0.55 | 1.4 | 0.17 | 2.65 | 0.73 | 1.00E+15 |

For example, a 200 μm long by 30 μm wide bi-layer beam including 10 μm thick Aluminum (Al) and 10 μm thick silicon nitride (Si₃N₄) has a fundamental resonance frequency of 567 kHz. Similarly, a 200 μm long by 30 μm wide tri-layer beam including 7 μm thick first Aluminum (Al), a 7 μm thick silicon nitride (Si₃N₄) layer and a second 7 μm thick Aluminum (Al) layer has a fundamental resonance frequency of 586 kHz.

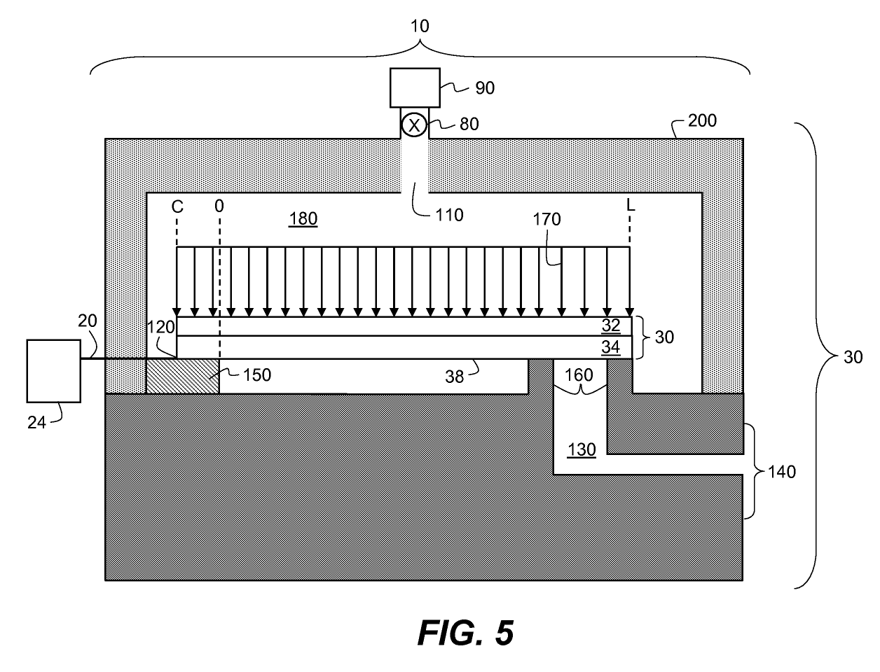

FIG. 5 shows a uniformly loaded cantilever beam flow control system. The figure is similar to that of FIG. 1A except that the unbalanced pressure region 170 extends the entire length of bimorph cantilever beam 30. As shown below when the unbalanced pressure region 170 acting on the cantilever beam 30 extends over its entire length L, the valve to function at pressures above 30 bar.

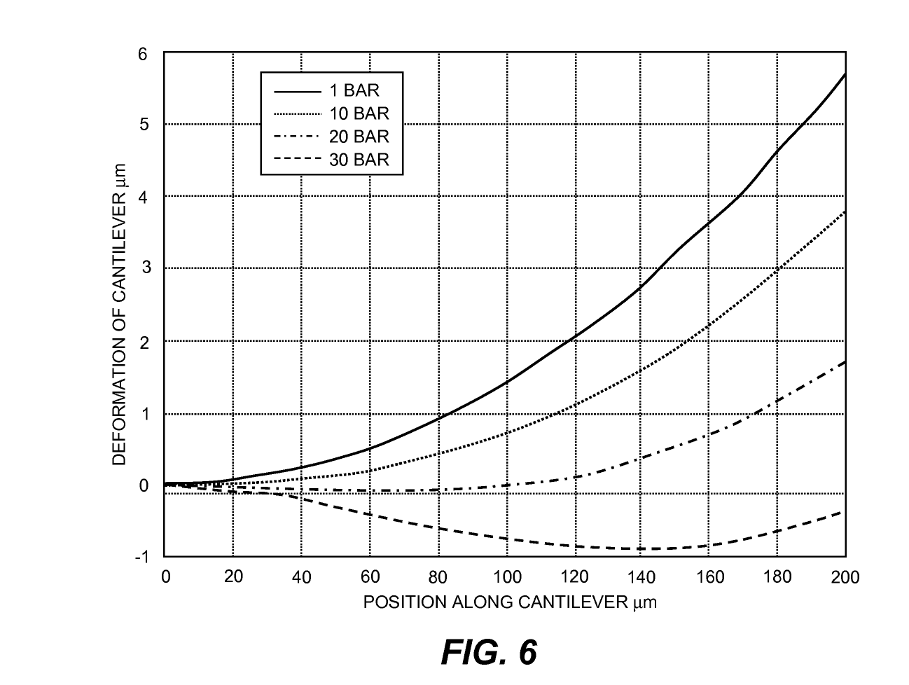

FIG. 6 shows curves of the deformation of a 200 μm long, 30 μm wide uniformly loaded bi-layer cantilever beam (mounted in the system shown in FIG. 5 and including 10 μm thick Aluminum (Al) and 10 μm thick silicon nitride (Si₃N₄)) as a function of position along the beam at 4 different loading pressures of 1 bar, 10 bar, 20 bar and 30 bar for a 200 degree temperature differential. The x axis is the position along the cantilever beam in microns, and the y axis is the deflection (deformation) in microns at position x. In order for a microvalve to open, the deflection should be positive over the position of the hole, otherwise it can not open. It has been determined that a micro-valve of this construction and dimensions functions suitably at pressures up to and including 28.4 bar (approximately 30 bar).

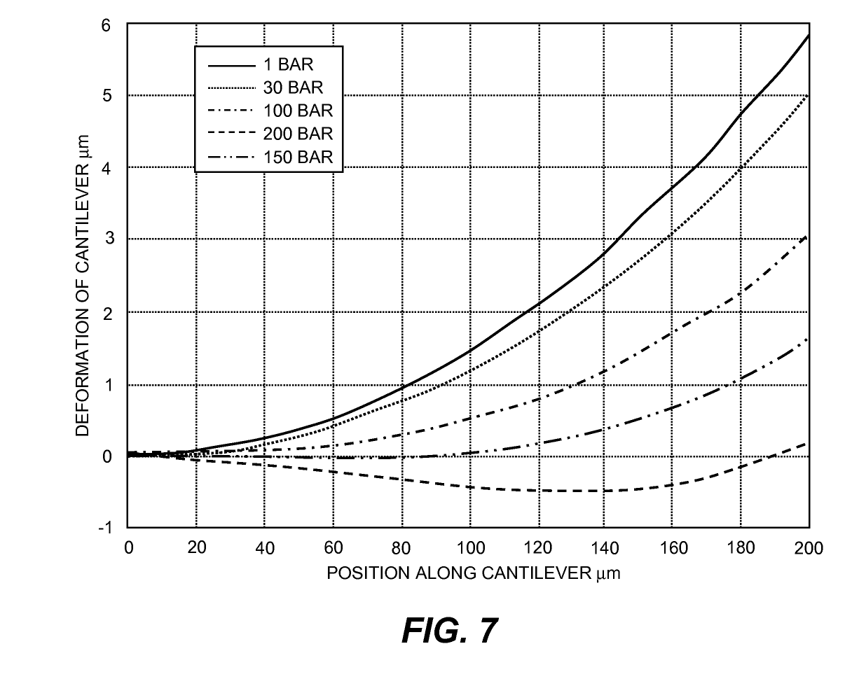

FIG. 7 shows curves of the deformation of the same type of cantilever beam 30 used in the discussion of FIG. 6 (mounted in the compressed fluid flow control system shown in FIG. 1 and including 200 μm long, 30 μm wide bi-layer of 10 μm thick Aluminum (Al) and 10 μm thick silicon nitride (Si₃N₄)) as a function of position along the beam at 5 different loading pressures of 1 bar, 30 bar, 100 bar, 150 bar and 200 bar for a 200 degree temperature differential. The position of A is at 150 μm and B is at 165 μm for the data shown in FIG. 7. The microvalve seat interface 60 is 5 μm long at A and B and the dimensions of the opening in the low pressure outlet port 130 is 5 μm by 20 μm. In order for the micro valve 30 to open, the deformation needs to be positive at the location of the opening in the microvalve seat interface 60. The micro valve of this design is suitable for use in environments including pressures of up to and including 180 bar (greater than or exceeding 30 bar).

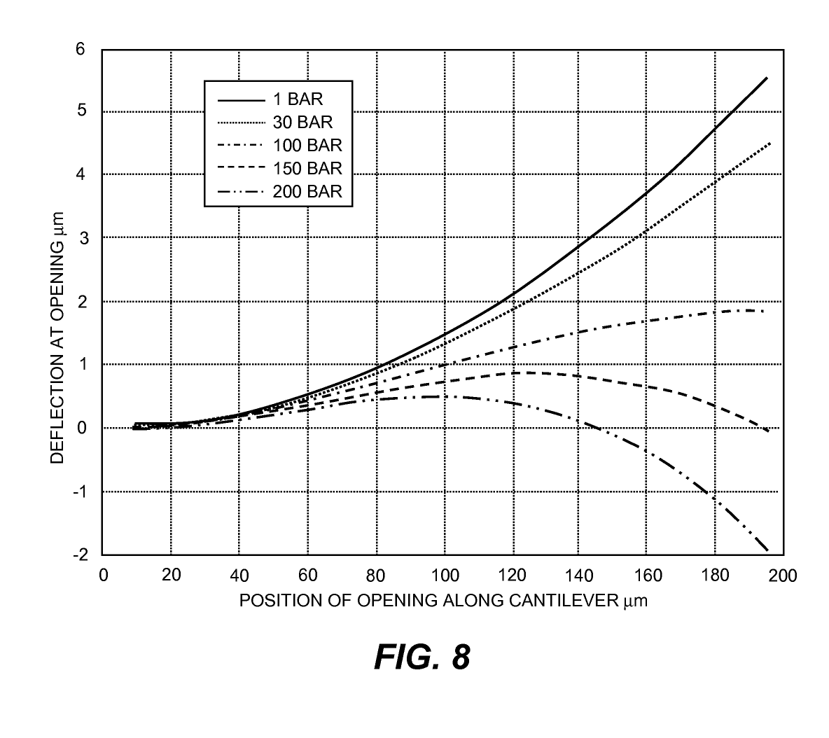

FIG. 8 shows curves of the deformation of the same type of cantilever beam 30 at the location of the opening in the microvalve seat interface 60 used in the discussion of FIGS. 6 and 7 (mounted in the compressed fluid flow control system shown in FIG. 1 and including 200 μm long, 30 μm wide bi-layer of 10 μm thick Aluminum (Al) and 10 μm thick silicon nitride (Si₃N₄)) as a function of the location of the microvalve seat 60 at 5 different loading pressures of 1 bar, 30 bar, 100 bar, 150 bar and 200 bar for a 200 degree temperature differential. The position of the opening for the data shown in FIG. 5 is defined as the point of the opening farthest from the pivot point 0. Thus for a 5 μm wide microvalve seat interface 60 the largest possible position of the opening would be 195 μm from the pivot point 0 for a 200 μm long beam. It is observed that moving point A closer to the pivot point 0 enables operation at higher pressures. For a pressure of 200 bar it is observed that this design will function as a valve if the position of the opening is less than 142 μm from the pivot point. Increasing the dimensions of the second portion of the cantilever beam results in lower maximum operating pressures for a given position of plane A. It is thus desirable that the length dimension of the second portion of the cantilever beam be less than 30% of the total length L.

The dynamics of thermally actuated cantilever beam microvalve operation depends on a number of time constants associated with various internal and external heat flows. The internal heat flows of the cantilever beam are driven by the temperature differential among layers. For the purpose of understanding the present invention, heat flow from a first layer to a second layer can be viewed as a heating process for the second layer and a cooling process for the first layer. For a tri-layer cantilever beam the middle layer can be viewed as establishing a time constant τ_{B} for heat transfer in both heating and cooling processes.

The time constant τ_{B} is approximately proportional to the square of the thickness of the middle layer and inversely proportional to the thermal conductivity of the materials used to construct this layer. The heat pulse input to the first layer should be shorter in duration than the heat transfer time constant τ_{B}, otherwise the potential temperature differential and deflection magnitude will be dissipated by excessive heat loss through the central layer.

A second heat flow path, from the cantilevered element to the surroundings, is also present. The details of the external heat flows will depend importantly on the application of the thermal actuator. Heat can flow from the actuator to substrate, or other adjacent structural elements, by conduction. Since the actuator is operating in a compressed fluid, it will lose heat via convection and conduction to the fluid. Heat will also be lost via radiation. For purpose of understanding the present invention, heat lost to the surroundings can be characterized as a single external cooling time constant τ_{S} that integrates the many processes and pathways that are operating.

Another timing parameter of importance is the desired repetition period τ_{C} for operating the thermal actuator. Since the heat transfer time constant τ_{B} governs the time required for the cantilevered element to restore to a first position, it is preferred that τ_{B}<<τ_{C} for energy efficiency and rapid operation. Uniformity in actuation performance from one pulse to the next will improve as the repetition period τ_{C} is chosen to be several units of τ_{B} or more. That is, if τ_{C}>5τ_{B} then the cantilevered element will have fully equilibrated and returned to the first or nominal position. If, instead τ_{C}<2τ_{B}, then there will be some significant amount of residual deflection remaining when a next deflection is attempted and the microvalve will not close.

The time constant of heat transfer to the surround, τ_{S}, can also influence the actuator repetition period τ_{C}. For an efficient design, τ_{S} will be significantly longer than τ_{B}. Therefore, even after the cantilevered element has reached internal thermal equilibrium after a time of 3 to 5τ_{B}, the cantilevered element will be above the ambient temperature or starting temperature, until a time of 3 to 5τ_{S}. A new deflection can be initiated while the actuator is still above ambient temperature. However, to maintain a constant amount of mechanical actuation, higher and higher peak temperatures for the layers of the cantilevered element will be required. Repeated pulsing at periods τ_{C}<3τ_{S} will cause continuing rise in the maximum temperature of the actuator materials until some failure mode is reached unless a heat sink is included in the design as a portion of the substrate. When a semiconductor or metallic material such as silicon is used for substrate, the indicated heat sink portion can be simply a region of the substrate designated as a heat sinking location. Alternatively, a separate material can be included within the substrate to serve as an efficient sink for heat conducted away from the cantilevered element at the anchor portion.

Another important aspect of the dynamic behavior of a thermally actuated microvalve is the flow of compressed fluid through the microvalve as a function of the deflection of the microvalve at the outlet port. The initial deflection of a cantilever beam creates a flow that is restricted by the dimensions of the outlet port and the magnitude of the deflection. The phenomenon of choked flow in compressed fluids occurs when the flow velocity through the outlet port of the microvalve reaches the sonic velocity. The mass flow rate of compressed fluid through the microvalve is a maximum under this condition. The pressure at the choke point is also fixed. As a result the unbalanced pressure across the cantilever beam will be less than when in the closed position. The cantilever beam will then deflect more than that expected from the initial unbalanced pressure across the cantilever beam. This is a novel and unanticipated feature of this invention. The amplification of deflection is a result of the initial deflection itself. The flow rate of the compressed fluid will thus depend on the restricting area of the opening at the outlet port. The total compressed fluid flow will thus be modulated by the frequency of operation of the microvalve.

### Example 1

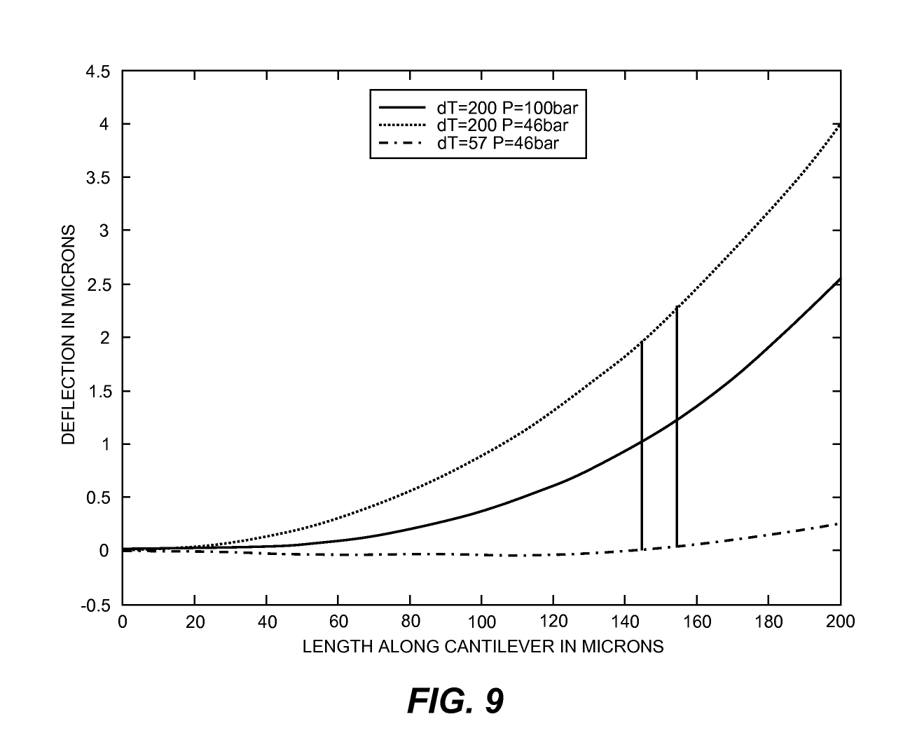

The operation of a 200 μm long by 30 μm wide tri-layer thermo-mechanical micro-valve designed according to the teachings of this invention was mathematically modeled. The tri-layer valve had a 7 μm thick silicon nitride (Si₃N₄) layer sandwiched between two 7 μm thick aluminum layers. The part of the tri-layer valve in constant contact at the anchor was 20 μm long and it served as a heat sink. Also, the valve seat opening was 10 μm long by 20 μm wide and was located at 145 μm from the anchor. Initially, the valve was at 40 degree C. and 100 bar pressure in the high pressure chamber, forcing it in a closed position on the valve seat. Then a voltage pulse was applied to raise the temperature of the bottom aluminum layer 200 degree C. above the ambient (40 degree C.) in 1 μsec. The solid curve in FIG. 9 shows the calculated static deflection profile of the cantilever beam under these conditions. The pressure drop across the cantilever beam at the outlet port is calculated to be 46 bar for the choked flow condition. The dotted curve in FIG. 9 shows the expected deflection profile of the cantilever beam under the choked flow condition. As seen in FIG. 9 this results in about a 2 μm deflection above the valve seat due to the differential expansion between the bottom aluminum layer and the silicon nitride layer. The heated layer then conducted heat through the silicon nitride layer to the top aluminum layer and the temperature of the thermo-mechanical valve became more uniform. As shown in the dot-dashed curve of FIG. 9, when the temperature differential decreased to 57 degrees C., the stresses due to the differential expansion are sufficiently reduced and the thermo-mechanical valve is restored to its closed position.

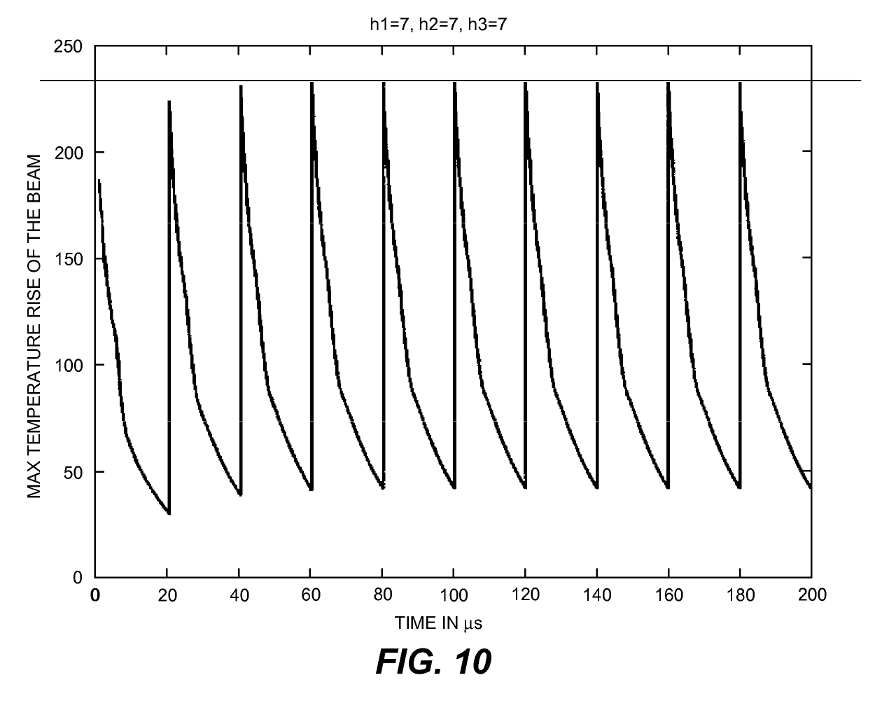

FIG. 10 shows the peak temperature rise of the cantilever beam as a function of time for periodic actuation at 50 KHz. The data show that after a few such successive initial voltage pulses, the peak temperature rise of the cantilever beam becomes stable around 238 C above the ambient. For 50 KHz pulse repetition frequency, computed mass flow rate delivered through the micro-valve was about 20 mg/sec for compressed carbon dioxide in its supercritical state. Operation at lower frequencies such as 10 kHz will result in lower peak temperature rise of the cantilever beam microvalve.

### Example 2

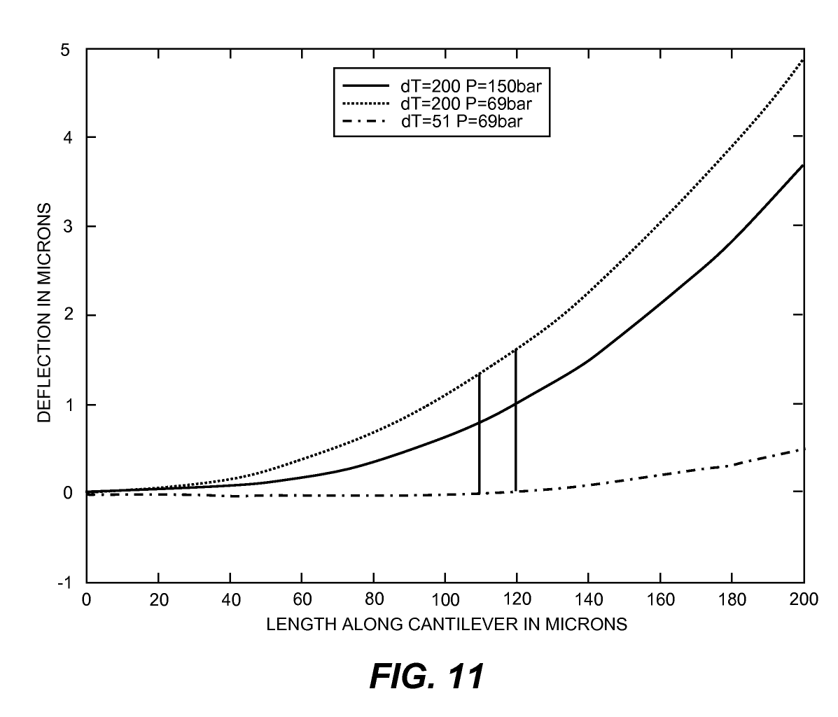

The operation of a 200 μm long by 30 μm wide bi-layer thermo-mechanical micro-valve designed according to the teachings of this invention was mathematically modeled. The bi-layer valve had 10 μm thick silicon nitride (Si₃N₄) top layer and a 10 μm thick aluminum bottom layer. The part of the bi-layer valve in constant contact at the anchor was 20 μm long and it served as a heat sink. Also, the valve seat was 10 μm long by 20 μm wide and was located at 110 μm from the anchor. Initially, the valve was at 40 degree C. and 150 bar pressure in the high pressure chamber, forcing it in a closed position on the valve seat. Then a voltage pulse was applied to raise the temperature of the bottom aluminum layer 200 degree C. above the ambient (40 degree C.) in 1 μsec. The solid curve in FIG. 11 shows the calculated static deflection profile of the cantilever beam under these conditions. The pressure drop across the cantilever beam at the outlet port is calculated to be 69 bar for the choked flow condition. The dotted curve in FIG. 11 shows the expected deflection profile of the cantilever beam under the choked flow condition. As seen in FIG. 11 this results in about a 1.6 μm deflection above the valve seat due to the differential expansion between the bottom aluminum layer and the silicon nitride layer. The heated layer then conducted heat through the silicon nitride and the temperature of the thermo-mechanical valve became more uniform. As shown in the dot-dashed curve of FIG. 11, when the temperature differential decreased to 51 degrees C., the stresses due to the differential expansion are sufficiently reduced and the thermo-mechanical valve is restored to its closed position.

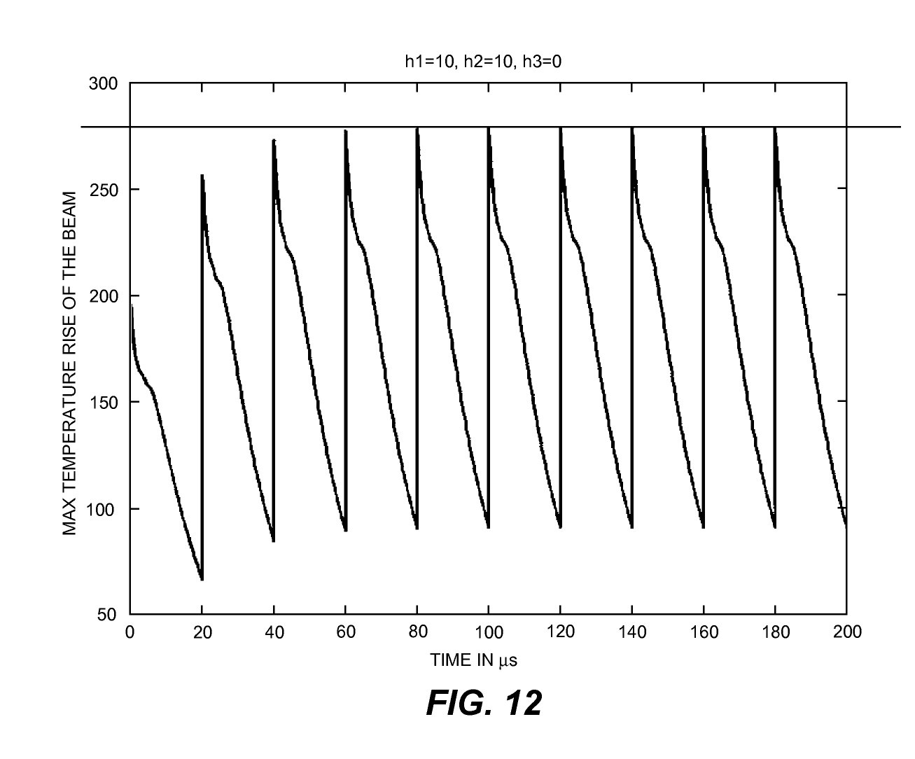

FIG. 12 shows the peak temperature rise of the cantilever beam as a function of time for periodic actuation at 50 KHz. The data show that after a few such successive initial voltage pulses, the peak temperature rise of the cantilever beam becomes stable around 280 C above the ambient. For 50 KHz pulse repetition frequency, computed mass flow rate delivered through the micro-valve was about 6 mg/sec for compressed carbon dioxide.

Table 2 below shows computational results of the microvalve operation described in Example 1 for different outlet port positions for a periodic actuation of 50 KHz.

TABLE 2

| | Outlet Port | | | | |
|---|---|---|---|---|---|
| | Position | | | | Max T |
| H | (μm from | P | Initial temp pulse, | Flow_rate | rise |
| (μm) | pivot) | (bar) | dT (deg C.) | (mg/s) | (deg C.) |
| 777 | 80-90 | 100 | 200 | 9.41 | 350 |
| 777 | 90-100 | 100 | 200 | 11.4 | 330 |
| 777 | 110-120 | 100 | 200 | 14.9 | 275 |
| 777 | 120-130 | 100 | 200 | 16.7 | 260 |
| 777 | 130-140 | 100 | 200 | 18.0 | 240 |
| 777 | 145-155 | 100 | 200 | 19.7 | 235 |
| 777 | 160-170 | 100 | 200 | 21.2 | 250 |
| 777 | 180-190 | 100 | 200 | 21.7 | 260 |
| 777 | 185-195 | 100 | 200 | 21.6 | 270 |

Two or more cantilever microvalves can also be placed in the same chamber described in FIGS. 1 and 2. Each microvalve would have its own outlet port so that each of the cantilevers could be controlled individually. A microfluidic device including arrays of microvalves as described in Examples 1 and 2, placed in a common chamber can be constructed into linear arrays with a center to center spacing of <200 μm, and preferably 42 μm corresponding to a printing density of 600 dpi.

While the previous discussions have been described in terms of thermally actuated micro cantilever beams, it is known that the same underlying principles can also apply to piezoelectric cantilever beams. Systems that incorporate piezoelectric devices have been described, for example, by Kyser et. al. in U.S. Pat. No. 3,946,398; Zolten in U.S. Pat. No. 3,683,212; Stemme in U.S. Pat. No. 3,747,120; Howkins in U.S. Pat. No. 4,459,601; and Fischbeck in U.S. Pat. No. 4,584,590. Piezoelectric tri-morph actuation mechanisms and optimization of actuator dimensions have been described, for example, by Gemmen et al. in U.S. Pat. No. 7,159,841. Additionally, Kluge discloses a piezoelectrically actuated microvalve in U.S. Pat. No. 6,142,444.

The invention has been described in detail with particular reference to certain preferred embodiments thereof, but it will be understood that variations and modifications can be effected within the scope of the invention.

### PARTS LIST

10 Uniformly loaded cantilever beam flow control system
20 Controller interface conduit
24 Controller
30 Bi-Layer cantilever beam microvalve
32 Cantilever second layer
34 Cantilever first layer
36 Electrode
38 Electrode surface of cantilever first layer
40 Electrode contact pads
50 Electrode gap
60 Microvalve seat interface
70 Microvalve enclosure
80 Compressed fluid inlet control valve
90 Compressed fluid source
100 Compressed fluid flow control system
110 Compressed fluid Inlet port
120 Cantilever electrode contact region
130 Low pressure outlet port
140 Microvalve enclosure base
150 Microvalve anchor
160 Microvalve seat
170 Unbalanced force region
180 Chamber
190 Tri-layer cantilever beam microvalve
192 Cantilever third layer
194 Cantilever second layer
196 Cantilever first layer
200 Microvalve enclosure top

1. A micro-electromechanical device for controlling compressed fluid flow comprising:
a chamber including a fluid flow inlet port, a high pressure region exceeding 30 bar, and a fluid flow outlet port;
a moveable micro-electromechanical valve positioned to contact the fluid flow outlet port when the moveable micro-electromechanical valve is in a first position; and
an electrical connection to the moveable micro-electromechanical valve that provides an electrical pulse train to the moveable micro-electromechanical valve to actuate the valve at a rate of 10 KHz or more to move the valve to control fluid communication between the high pressure region and a low pressure region downstream from the fluid flow outlet port.

2. The device of claim 1, the movable micro-electromechanical valve being a first valve, the fluid flow outlet port being a first fluid flow outlet port, further comprising:
a second movable micro-electromechanical valve positioned to contact a second fluid flow outlet port.

3. The device of claim 2, wherein the first outlet port is spaced apart from the second outlet port by a spacing of less than 200 μm.

4. The device of claim 1, wherein portions of the fluid flow outlet port define a valve seat that provides a seal when in contact with the micro-electromechanical valve.

5. The device of claim 1, wherein the movable micro-electromechanical valve is normally closed.

6. The device of claim 1, wherein the movable micro-electromechanical valve includes a multi-layer thermo-mechanical device.

7. The device of claim 1, wherein the movable micro-electromechanical valve includes a multi-layered piezoelectric device.

8. The device of claim 1, further comprising a source of compressed fluid connected to the inlet port of the chamber.

9. The device of claim 8, wherein the compressed fluid includes carbon dioxide.

10. A method of controlling compressed fluid flow comprising:
providing a source of compressed fluid, the compressed fluid being under a pressure of at least 30 bar;
providing a micro-electromechanical device including:
a chamber including a fluid flow inlet port, a high pressure region, and a fluid flow outlet port, the fluid flow inlet port being in fluid communication with the source of compressed fluid;
a moveable micro-electromechanical valve positioned to contact the fluid flow outlet port when the moveable micro-electromechanical valve is in a first position; and
an electrical connection to the moveable micro-electromechanical valve; and
actuating the moveable micro-electromechanical valve at a rate of 10 KHz or more by providing an electrical pulse train to the moveable micro-electromechanical valve using the electrical connection to control fluid communication between the high pressure region and a low pressure region downstream from the fluid flow outlet port.

11. The method of claim 10, wherein the movable micro-electromechanical valve is normally closed.

12. The method of claim 10, wherein the movable micro-electromechanical valve includes a multi-layer thereto-mechanical device.

13. The method of claim 10, wherein the movable micro-electromechanical valve includes a multi-layered piezoelectric device.

14. The method of claim 10, wherein the compressed fluid includes carbon dioxide.
